(19) United States
(12) Patent Application Publication
(10) Pub. No.: US 2002/0127027 A1
(43) Pub. Date: Sep. 12, 2002

(54) Image forming apparatus

(76) Inventors: Keisuke Kubota, Hitachinaka (JP); Teruaki Mitsuya, Hitachinaka (JP); Hiroyuki Mabuchi, Hitachinaka (JP); Masayoshi Ishii, Hitachinaka (JP); Shinichi Akatsu, Hitachinaka (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/092,522

(22) Filed: Mar. 8, 2002

(30) Foreign Application Priority Data
Mar. 9, 2001 (JP) 2001-66086
May 18, 2001 (JP) 2001-148869

(51) Int. Cl. G03G 15/06

(52) U.S. Cl. 399/55; 399/51; 399/48; 399/44; 399/50

(57) ABSTRACT

An image forming apparatus restricts disturbance of a potential patch in the case where a potential sensor for detecting the potential patch is provided downstream side of a developing device of a multiple developing roller type to enable stable reproduction of a high quality image for a long period. The apparatus includes a potential sensor provided downstream side of moving direction of the image carrier relative to the developing means for detecting a potential on the image carrier, and controller setting the developing bias to a value restricting disturbance of a potential portion as an object for potential detection by the potential sensor by the developer when the potential portion passes across the developing means.

### BACKGROUND OF THE INVENTION

The present invention relates to an image forming apparatus represented by a printer, a copy machine, a facsimile and so on.

In an image forming apparatus represented by a printer, a copy machine, a facsimile and so on, it has been well known so-called an electrophotographic process, in which a photo conductor as an image carrier is charged, an image exposure on the charged photo conductor is performed for recording an electrostatic latent image, a developer is supplied to the photo conductor carrying the electrostatic latent image for developing the electrostatic latent image, and a toner image thus formed on the photo conductor is transferred to a paper, an OHP sheet or a recording body, such as an intermediate transfer body, to obtain a printed image.

In the image forming apparatus of this kind, in consideration for stably reproducing a high image quality for a long period, there has been known a mechanism, in which a patch is formed on the surface of the image carrier body before initiation of printing operation, after printing operation or during printing operation and various parameters associating with printing is controlled on the basis of the information obtained from the patch. Here, in the patch employed for such control, there are constructions for performing control using a “toner patch” formed by depositing toner on the image carrier body and a construction for performing control using a “potential patch” formed as a latent image without depositing the toner.

In case of the toner patch system, since the toner image has to be formed on the image carrier body, extra amount of toner is consumed. Furthermore, since the toner patch has to be removed from the image carrier body, load on a cleaning device can be increased.

In contrast to this, in case of the potential patch, it is sufficient to form the latent pattern on the image carrier body by charging step and exposure step to solve the problems set forth above. Then, in the prior art, as disclosed in Japanese Patent Application Laid-Open No. Heisei 9 (1997)-230688, it is typical to provide a potential sensor for detecting the potential patch between an exposure device and a developer device for detecting potential before the developer device.

However, upon speeding up a printing speed of the image forming apparatus, greater amount of developer has to be supplied to the image carrier body. As one approach, a multiple stage developing roller system having a plurality of developing rollers has been employed.

However, when the multiple stage developing roller type developing device us employed, associating with increasing of size, difficulty is encountered for certainly attaining space for mounting the potential sensor between the exposure device and the developing device.

On the other hand, mounting the potential sensor between the exposure device and the developing device is not always appropriate in view point of speeding of the printing speed. Namely, it is possible that the potential patch may pass below the potential sensor before the potential of the exposure portion drops down to the predetermined potential due to optical response characteristics of the image carrier body (photo conductor) to make it impossible to accurately detect the potential patch.

### SUMMARY OF THE INVENTION

Accordingly, an object of the present invention is to provide an image forming apparatus, which restricts disturbance of a potential patch in the case where a potential sensor for detecting the potential patch is provided downstream side of a developing device of a multiple developing roller type to enable stable reproduction of a high quality image for a long period.

In order to accomplish the above-mentioned and other objects, according to the first aspect of the present invention, an image forming apparatus comprises: charging means for charging an image carrier; exposure means for exposing image on the charged image carrier for forming a latent image; developing means including a plurality of developing rollers arranged in opposition with a surface of the image carrier and biasing applying means for applying a developing bias to the plurality of developing roller, for supplying a developer on the image carrier and forming a developed image on the image carrier; transfer means for transferring the developed image formed on the image carrier onto a printing medium; a potential sensor provided downstream side of moving direction of the image carrier relative to the developing means for detecting a potential on the image carrier; and control means for setting the developing bias to a value restricting disturbance of a potential portion as an object for potential detection by the potential sensor by the developer when the potential portion passes across the developing means.

Preferably, setting of the developing bias for the plurality of developing rollers may be performed in sequential order from the developing roller arranged on upstream side in the moving direction of the image carrier.

According to the second aspect of the present invention, an image forming apparatus comprises: an image carrier; charging means for charging an image carrier; exposure means for exposing image on the charged image carrier for forming a exposure portion potential; developing means including a plurality of developing rollers arranged in opposition with a surface of the image carrier, biasing applying means for applying a developing bias to the plurality of developing roller and a two component developer, for supplying a developer on the image carrier and forming a developed image on the image carrier; transfer means for transferring the developed image formed on the image carrier onto a printing medium; a potential sensor provided downstream side of moving direction of the image carrier relative to the developing means for detecting a potential on the image carrier; and control means for avoiding the developing bias to a value for restricting deposition of toner to the exposure portion potential when the exposure portion potential region passes across the developing means.

According to the third aspect of the present invention, an image forming apparatus comprises: an image carrier; charging means for charging an image carrier; exposure means for exposing image on the charged image carrier for forming a exposure portion potential; developing means including a plurality of developing rollers arranged in opposition with a surface of the image carrier, biasing applying means for applying a developing bias to the plurality of developing roller and a two component developer, for supplying a developer on the image carrier and forming a developed image on the image carrier; transfer means for transferring the developed image formed on the image carrier onto a printing medium; a potential sensor provided downstream side of moving direction of the image carrier relative to the developing means for detecting a charge potential and an exposure potential on the image carrier; and control means for applying the developing bias at a value restricting splashing of carrier to the surface of the image carrier when the charge potential region passes through the developing means, and avoiding the developing bias to a value for restricting deposition of toner to the exposure portion potential when the exposure portion potential region passes across the developing means.

According to the fourth aspect of the present invention, an image forming apparatus comprises: an image carrier;

charging means for charging an image carrier; exposure means for exposing image on the charged image carrier for forming a exposure portion potential; developing means including a plurality of developing rollers arranged in opposition with a surface of the image carrier, biasing applying means for applying a developing bias to the plurality of developing roller and a two component developer, for supplying a developer on the image carrier and forming a developed image on the image carrier; transfer means for forming a transfer nip portion by contacting with the surface of the image carrier and transferring the developed image formed on the image carrier onto a printing medium in the transfer nip; a potential sensor provided downstream side of moving direction of the image carrier relative to the developing means for detecting a charge potential and an exposure potential on the image carrier; and control means for applying the developing bias at a value restricting splashing of carrier to the surface of the image carrier when the charge potential region passes through the developing means, and avoiding the developing bias to a value for restricting deposition of toner to the exposure portion potential when the exposure portion potential region passes across the developing means.

In the preferred construction, the developing bias may be avoided in sequential order from the developing roller arranged upstream side in moving direction of the image carrier upon avoiding developing bias of a plurality of developing rollers. The developing bias may be applied in sequential order from the developing roller arranged upstream side in moving direction of the image carrier upon applying developing bias of a plurality of developing rollers.

The image forming apparatus may further comprise: layer thickness detecting means for detecting a layer thickness of the image carrier; a humidity sensor for detecting humidity around the image carrier; and dark decay storage means for storing a potential drop amount due to dark decay of the image carrier corresponding to detection values of the layer thickness detecting means and the humidity sensor, and at least one of a charge voltage of the charging means and a light amount of the exposure means is corrected on the basis of the potential drop derived from the detection values of the layer thickness detecting means and the humidity sensor.

According to the fifth aspect of the present invention, an image forming apparatus comprises: an image carrier; charging means for charging an image carrier; exposure means for exposing image on the charged image carrier for forming a exposure portion potential; developing means including a developing roller arranged in opposition with a surface of the image carrier, biasing applying means for applying a developing bias to the developing roller and a two component developer, for contacting the developer held on the developing roller to the surface of the image carrier to form a developing nip and supplying a developer on the image carrier and forming a toner image on the image carrier in the developer nip; transfer means for transferring the toner image formed on the image carrier onto a printing medium in the transfer nip; a potential sensor provided downstream side of moving direction of the image carrier relative to the developing means for detecting a charge potential and an exposure potential on the image carrier; and control means for avoiding the developing bias to a value for restricting deposition of toner to the exposure portion potential when a tip end of the exposure portion potential region reaches a rear end of the developing nip in moving direction of the image carrier.

The image forming apparatus preferably comprises means for controlling a potential of an image region on the basis of a detection value of the potential sensor constant, detecting a layer thickness of a photo conductor layer forming the image carrier, and controlling peripheral electric field of the image region.

The image forming apparatus may include: a first potential sensor arranged within a range from the developing means toward the charging means in the moving direction of the image carrier, and a second potential sensor arranged within a range from the charging means toward the developing means in the moving direction of the image carrier, a potential of the charge potential region is controlled to be constant on the basis of a detection value of the second potential sensor, and the layer thickness of the photo conductor is detected on the basis of a detection value of the first potential sensor.

The image forming apparatus may employ an auxiliary exposure for controlling the peripheral electric field, an auxiliary exposure light is irradiated at a position of transition from a potential of the charge potential region to the exposure potential region for forming stepwise potential distribution. At least one stepwise potential distribution may be formed between the developing bias voltage and a potential of the charge potential region.

The image forming apparatus may further comprise means for detecting a potential of an image region where is a region of the latent image, by the potential sensor, controlling the potential of the image region other than solid image region among the image region on the basis of detection values thereof, detecting a later thickness of the photo conductor and controlling a peripheral electric field of the image region including the solid image.

### BRIEF DESCRIPTION OF THE DRAWINGS

The present invention will be understood more fully from the detailed description given hereinafter and from the accompanying drawings of the preferred embodiment of the present invention, which, however, should not be taken to be limitative to the invention, but are for explanation and understanding only.

In the drawings:

FIG. 1 is a diagrammatic block diagram of the preferred embodiment of an image forming apparatus according to the present invention;

FIG. 2 is an explanatory illustration showing a toner coverage and a potential sensor detection error;

FIG. 3 is an explanatory illustration showing a relationship between a background potential difference and a carrier splashing:

FIG. 4 is an explanatory illustration showing a toner developing region on a photo conductor when carrier splashing is not caused;

FIG. 5 is a diagrammatic illustration showing a timing of avoidance of a developing bias of a developing device having single developing roller;

FIG. 6 is a diagrammatic illustration showing a timing of avoidance of a developing bias of a developing device having two developing rollers;

FIG. 7 is a flowchart of a developing bias control for detecting a potential after development;

FIG. 8 is an explanatory illustration showing a surface potential of the photo conductor at a developing position and a position after development;

FIG. 9 is an explanatory illustration showing a dark decay characteristics of the photo conductor depending upon humidity;

FIG. 10 is an explanatory illustration showing a dark decay characteristics of the photo conductor depending upon a layer thickness:

FIG. 11 is an explanatory illustration showing a relationship between a surface charge density depending upon a layer thickness of the photo conductor and a background potential;

FIG. 12 is a flowchart showing a process of humidity detection;

FIG. 13 is a flowchart showing a process of calculation of a surface charge density of the photo conductor;

FIG. 14 is a flowchart showing a process of calculation of a potential at the developing position;

FIG. 15 is an explanatory illustration showing one example of a matrix table of a dark decay storage portion;

FIG. 16 is a diagrammatic illustration of the preferred embodiment of the image forming apparatus;

FIG. 17 is a timing chart of a developing bias application upon initiation of printing;

FIG. 18 is a timing chart of the developing bias application of a developing device having a plurality of developing rollers;

FIG. 19 is an explanatory illustration showing an optical response characteristics of a photo conductor drum;

FIG. 20 is an explanatory illustration showing the optical response characteristics of an initial condition and a fatigue condition of the photo conductor drum;

FIGS. 21A and 21B are explanatory illustrations showing one example of a potential of latent image on the photo conductor drum and an electric field distribution;

FIG. 22 is an explanatory illustration showing variation after charging of the surface potential of the photo conductor drum;

FIG. 23 is an explanatory illustration showing variation relative to a reduction amount of a photo conductor layer thickness of a dark decay potential difference ÄVd;

FIG. 24 is an explanatory illustration showing a potential distribution of the photo conductor drum surface upon developing when a circumferential electric field control is performed;

FIG. 25 is an explanatory illustration showing the potential and electric field distribution of a Vr2 image region depending upon presence and absence of control;

FIG. 26 is a diagrammatic illustration showing another embodiment of the image forming apparatus according to the present invention; and

FIG. 27 is a diagrammatic illustration showing a further embodiment of the image forming apparatus according to the present invention.

### DESCRIPTION OF THE PREFERRED EMBODIMENT

The present invention will be discussed hereinafter in detail in terms of the preferred embodiment of the present invention with reference to the accompanying drawings. In the following description, numerous specific details are set forth in order to provide a thorough understanding of the present invention. It will be obvious, however, to those skilled in the art that the present invention may be practiced without these specific details. In other instance, well-known structure is not shown in detail in order to avoid unnecessary obscurity of the present invention.

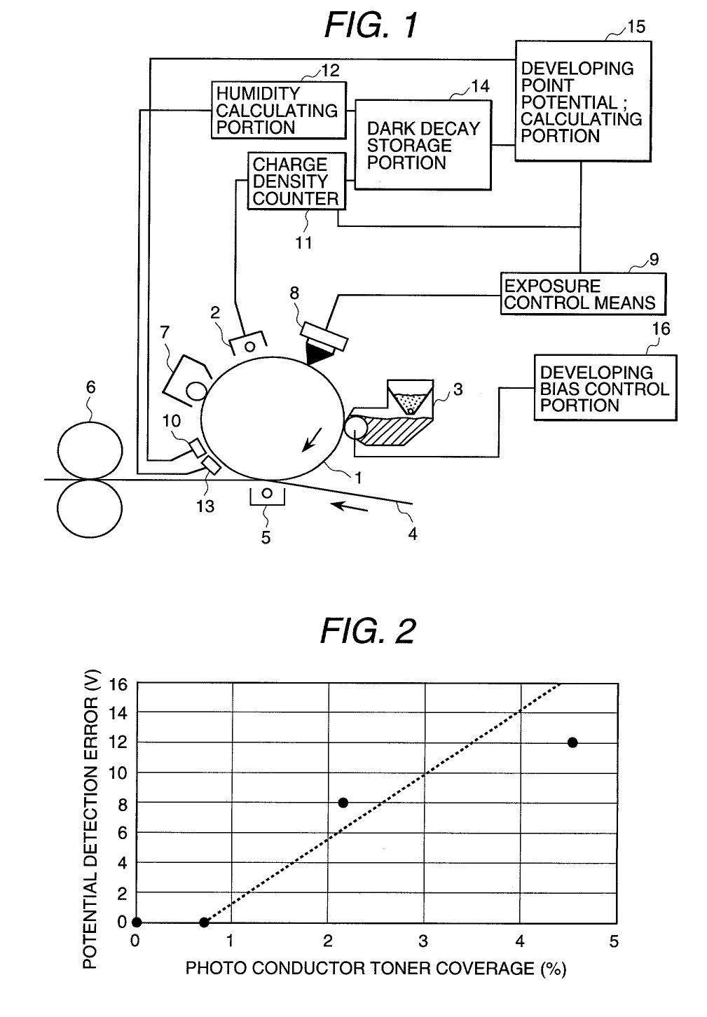

FIG. 1 is a diagrammatic block diagram of the preferred embodiment of an image forming apparatus according to the present invention. In the drawings, the reference numeral 1 denotes a photo conductor drum 1 as one example of an image carrier, 2 denotes a charger, 3 denotes a developing device, 4 denotes a printing paper as one example of a printing medium, 5 denotes a transfer device, 6 denotes a fixing device, 7 denotes a cleaning device, 8 denotes an exposure device, 9 denotes an exposure control means, 10 denotes a potential sensor, 11 denotes a charge density counter, 12 denotes a humidity calculating portion, 13 denotes a temperature and humidity sensor, 14 denotes a dark decay storage portion, 15 denotes a developing point potential calculating portion and 16 denotes a developing bias control portion.

The photo conductor drum 1 uniformly charged by the charger 2 is exposed an image by the exposure device 8 which includes a semiconductor laser and its optical system light emission of which is controlled by exposure control means 9, such as a laser driver or the like, to form an electrostatic latent image on the surface of the photo conductor drum 1.

The electrostatic latent image formed on the photo conductor drum 1 is developed by the developing device 3 to form a toner image. The toner image formed on the photoconductor drum 1 is transferred to a printing paper 4 by a transfer device 5. Subsequently, the toner image transferred to the printing paper 4 is heat-fused by the fixing device 6. On the other hand, a residual toner on the photo conductor drum 1 not transferred to the printing paper 4 and remained thereon is collected by the cleaning device 7. Then, a series of process is finished.

The potential of the surface of the photo conductor drum 1 is detected by the potential sensor 10 arranged downstream side in rotating direction of the photo conductor drum with respect to the developing device 3. An exposure amount of the exposure device 8 can be adjusted by the exposure control means 9 on the basis of “corrected detection value=(|vr′|+β)” which is derived by adding the dark decay potential amount β to a detection value Vr′. On the other hand, a charge density of the surface of the photo conductor drum 1 is counted by the charge density counter 11, and an exposure amount of the exposure device 8 is adjusted by the exposure control means 9 on the basis of the counted value.

Next, discussion will be given for a potential detection method at a position after transfer in terms of an exposure portion potential vr on the photo conductor drum 1 as detection object by the potential sensor 10, for example.

The exposure portion potential Vr formed on the photo conductor drum 1 by the exposure device 8 is developed to form the toner image by a potential difference to a developing bias Vb applied by the developing roller and tends to be approximately equal potential as the developing bias Vb. In short, the potential on the surface of the photo conductor drum 1 is determined adapting to the level of the developing bias Vb.

Accordingly, in the shown embodiment, in order to detect the exposure portion potential Vr, control is performed for avoiding the developing bias so as not to develop the latent image to form the toner image on the surface of the photo conductor drum.

FIG. 2 is plotted with taking the toner coverage on the surface of the photo conductor drum 1 in a horizontal axis and a detection error by the potential sensor 10 in a vertical axis. In the embodiment, as a condition where the detection value of the potential sensor 10 is not influenced by toner development, the development bias is set so that a toner coverage on the surface of the photo conductor drum 1 becomes less than or equal to 0.7%.

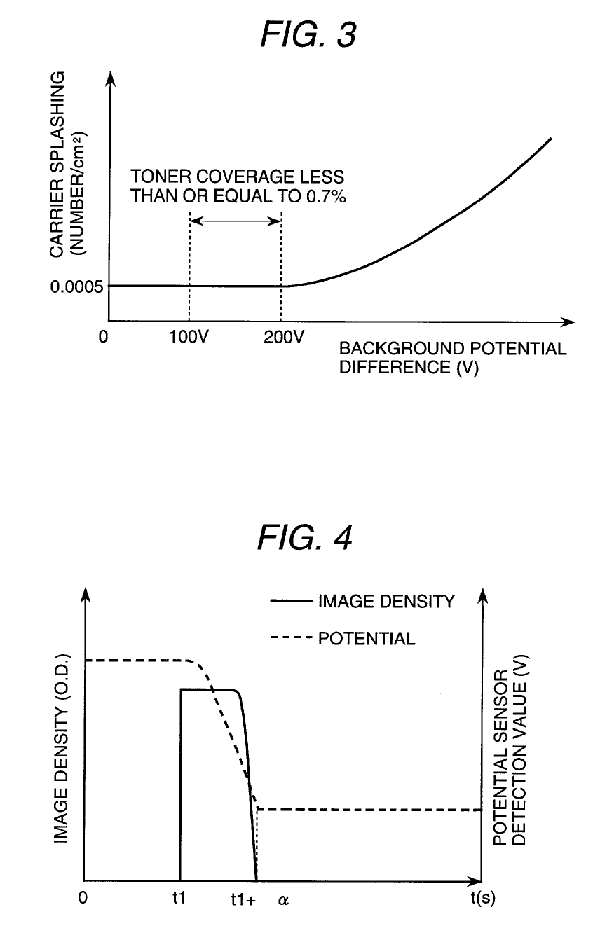

FIG. 3 is an illustration showing a carrier splashing number caused associating with avoidance of the developing bias. In FIG. 3, the horizontal axis represents the background potential difference and the vertical axis represents the carrier splashing number. When two-component developing system is employed as developing system, if the developing bias is avoided at a timing where a region of the background potential (charged potential region) passes through the developing roller, a potential difference between the developing bias Vb′ after avoidance of the developing bias and the background potential becomes large to draw a carrier charged in opposite polarity to the toner by an electrical field in the direction toward the photo conductor formed by the developing bias Vb′ and the background potential to cause carrier splashing.

Therefore, in the present invention, the background potential difference is set so as not to cause carrier splashing and to satisfy the toner coverage on the photo conductor drum less than or equal to 0.7%. The developing bias Vb′ after the avoidance is set so that the background potential difference may fall within a range between 100V to 200V in the embodiment.

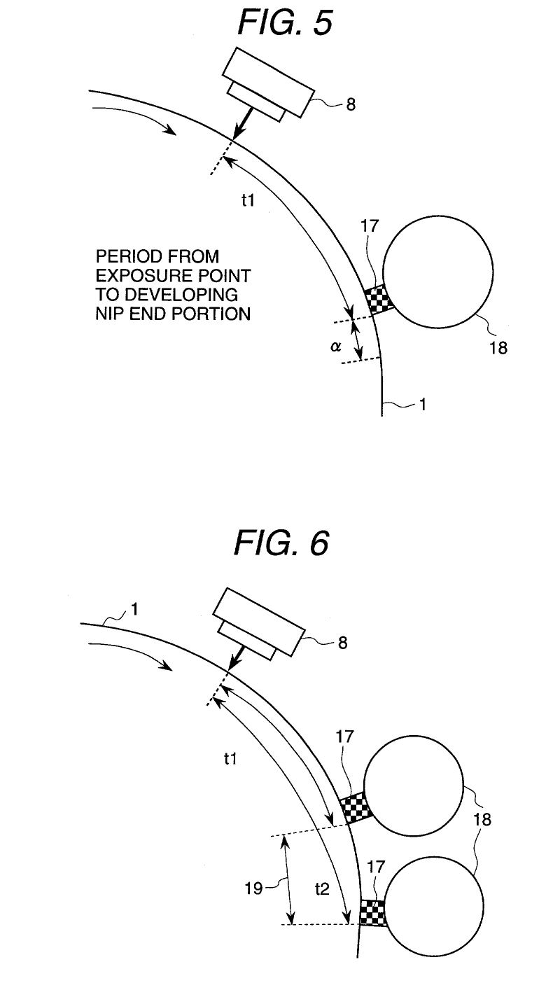

FIG. 4 is an illustration showing a case where avoidance of the developing bias is actually performed and the potential after transfer is detected. In FIG. 4, the horizontal axis represents a time and the vertical axis represents an image density and a detection value of the potential sensor. FIG. 5 diagrammatically shows a timing for avoiding the developing bias in case of the developing device having a single developing roller. In order to avoid occurrence of carrier splashing, it becomes necessary to avoid the developing bias at a timing where the detection objective potential Vr passes across the developing nip portion. A period t1 from the exposure point to pass through the developing nip portion is preliminarily measured. By avoiding the developing bias from Vb to Vb′ at a timing after a period t1 from the exposure timing upon potential detection, a condition for satisfying prevention of carrier splashing and prevention of detection error of the potential sensor by toner development, can be established.

On the other hand, the potential detection timing at this time is set with a delay for a period corresponding to total period Δα of a period corresponding to the developing nip width and a falling down period of internal power source for supplying the developing bias, which total period corresponds to a period in which the toner image of a width in circumferential direction of the photo conductor drum is formed through development.

Accordingly, in the shown embodiment of the image forming apparatus, by setting the level of avoidance of the development bias and timing as set forth above, potential detection by the potential sensor after development becomes possible.

Next, discussion will be given for the case of the development device having two or more developing rollers with reference to FIG. 6. When developing bias of two or more developing rollers is voided simultaneously, considering carrier splashing, the toner image is formed on the photo conductor drum by development by the developing potential difference of one developing roller for a distance Δd between the developing nips. When number of the developing rollers is N, the toner image is formed in a range of (N−1)×Δd in the peripheral direction of the photo conductor by development. By this, it should be easily appreciated that the potential detection region is significantly increased according to increase of number of developing rollers.

In order to solve the foregoing problem, in the shown embodiment, a method is taken to avoid the developing bias in sequential order from upstream side toward rotating direction of the photo conductor, such as respective timings t1, t2 for the developing device having two or more developing rollers. By this, potential detection becomes possible at the equal area as that of the image forming apparatus having single developing roller.

It should be noted that while the developing device having two developing rollers is exemplarily illustrated in FIG. 6, similar method can equally be employed for the developing device having three or more developing rollers. On the other hand, the potential level of the developing bias after avoidance and the timing of avoidance of developing bias are the same as those in the case of the developing device having one developing roller.

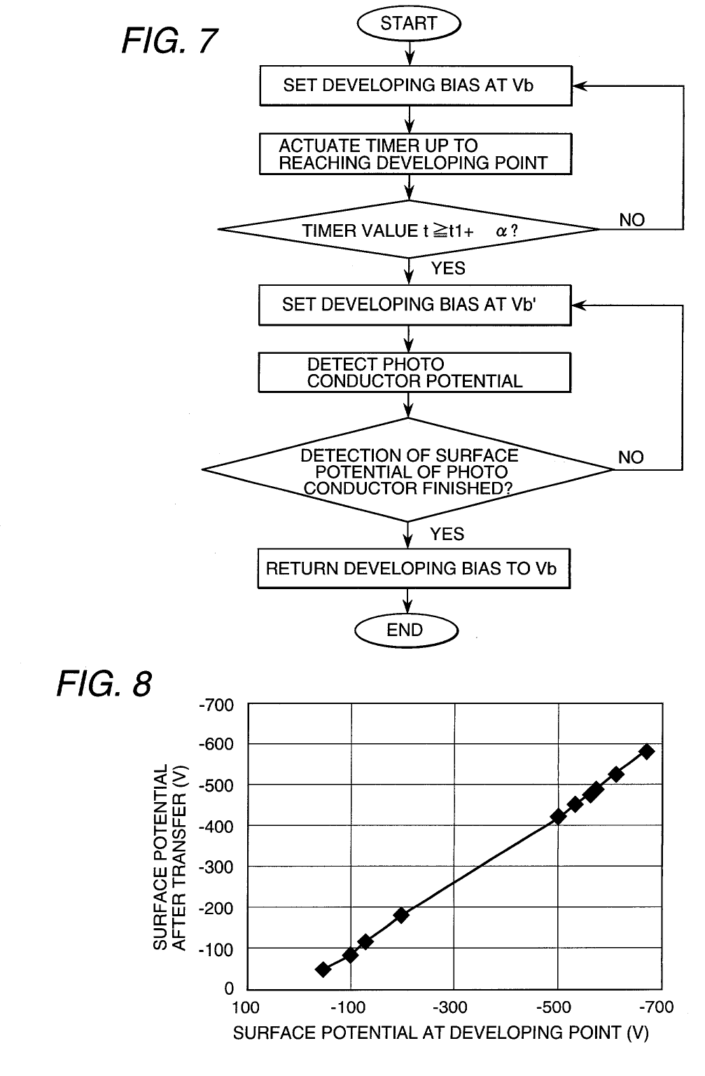

FIG. 7 is a flowchart of a developing bias control for detecting potential on upstream side of the developing roller in rotating direction of the photo conductor. Furthermore, in the shown embodiment of the image forming apparatus, a system for adding a potential correction amount is employed for reproducing the potential at the position of the developing device. The detection value of the potential sensor includes a dark decay component depending upon elapsed time after exposure of the photo conductor and thus the potential at the timing of development is different from the potential detection value after transfer. The dark decay characteristics of the photo conductor are variable depending upon layer thickness of the photo conductor and humidity.

FIG. 8 shows the detection values of the potential sensor at the developing position and a transfer position. In FIG. 8, the horizontal axis represents the surface potential of the photo conductor at the developing point and the vertical axis represents the surface potential of the photo conductor after transfer. It is appreciated that the charge potential of the photo conductor is lowered depending upon an elapsed period from charging to detection. This is noted as potential drop component due to dark decay characteristics of the photo conductor.

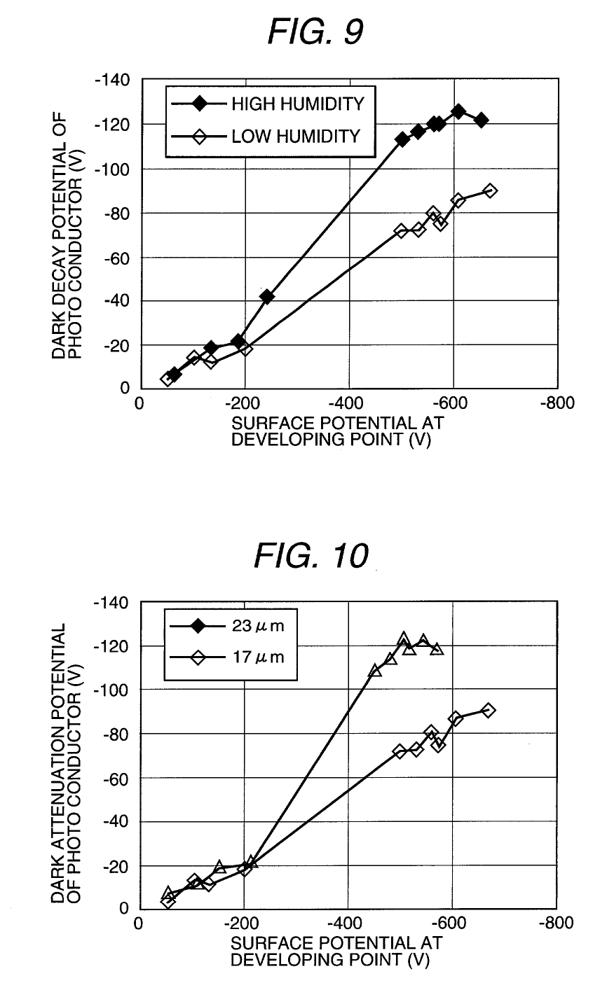

FIG. 9 shows a result of potential drop due to dark decay of the photo conductor depending upon humidity. At lower environmental humidity of the photo conductor, potential drop due to dark decay is lower. Conversely, at higher humidity, potential drop becomes greater.

FIG. 10 shows dark decay variation depending upon layer thickness of the photo conductor. According to increasing of number of printing sheet, the layer thickness of the photo conductor is reduced to increase potential drop due to dark decay. As can be appreciated from the results shown in FIGS. 8 to 10, the dark decay of the photo conductor depends on atmospheric environment of the photo conductor and the layer thickness of the photo conductor. Therefore, a dark decay potential amount β is preliminarily measured. In the shown embodiment, a method for predicting the layer thickness of the photo conductor by deriving a charge density on the surface of the photo conductor is calculated by a charge density counter 11 as a parameter depending upon the layer thickness of the photo conductor. Accordingly, the dark decay potential amount β is preliminarily set in a table established in terms of the humidity and the charge density of the surface of the photo conductor. The dark decay potential amount β set in the table are stored in the dark decay storage portion 14.

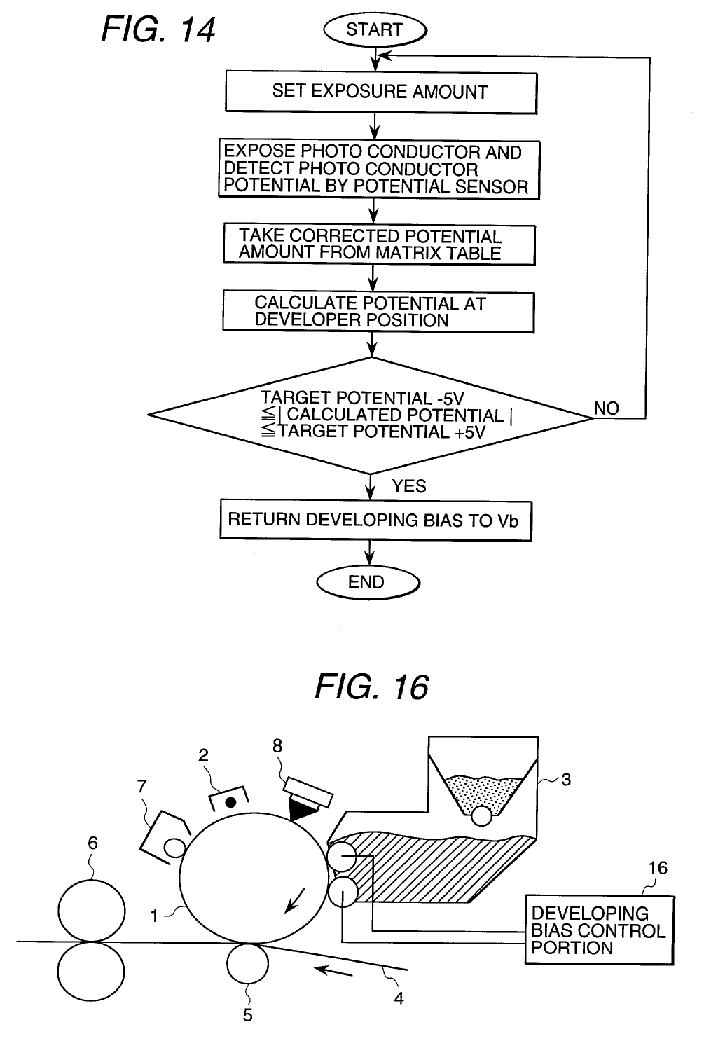

FIG. 15 shows a matrix table of the humidity and the surface charge density stored in the dark decay storage portion. Upon detection of potential, humidity is detected by a humidity sensor 13 arranged internally. Furthermore, the layer thickness of the photo conductor is detected by means of the charge density counter 11. FIG. 12 shows a flowchart showing a process for detecting internal humidity of the image forming apparatus. On the basis of the detection value, the dark decay potential amount of the photo conductor is extracted from the dark decay storage portion 14. Then, the potential on the surface of the photo conductor at the developing position is calculated by adding the detected potential and reproduced. FIG. 14 shows a flowchart calculating the potential of the surface of the photo conductor at the developing position.

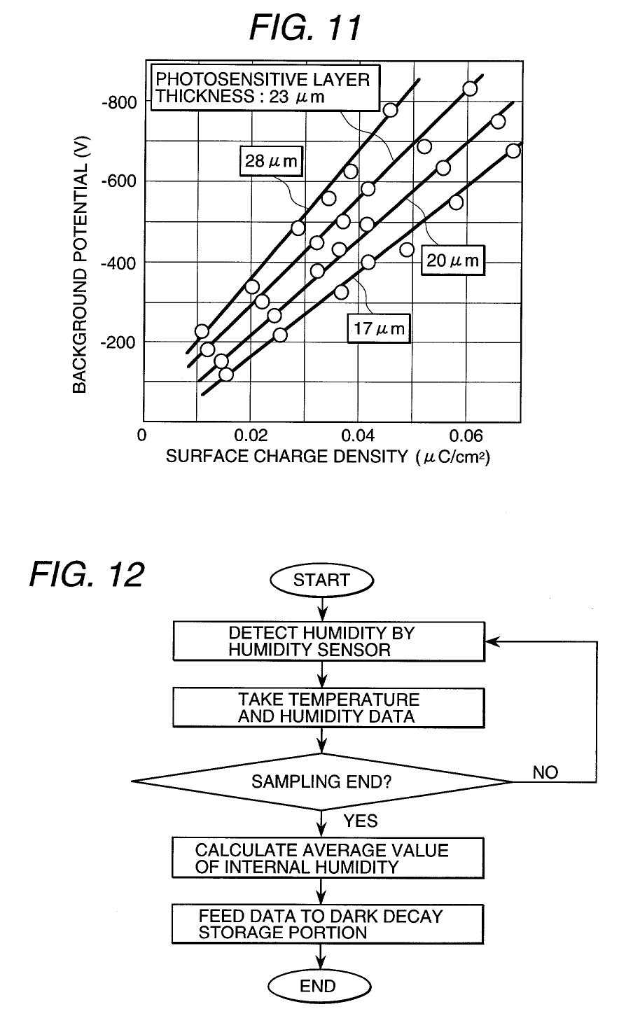

It should be noted that, in the shown embodiment of the image forming apparatus, a method for detecting the layer thickness of the photo conductor is to predict the layer thickness by measuring an inflow current by means of the charge density counter 11. FIG. 11 is an illustration showing a relationship between the surface charge density of the photo conductor drum 1 and a charge potential (background potential) 0V with taking the layer thickness of the photo conductor as a parameter. When the surface charge density and the background potential are known, the layer thickness of the photo conductor can be derived. In the shown embodiment of the image forming apparatus, a corotron type charger is employed as the charger. A difference between a current applied to a wire of the charger 2 and a current flowing through a shield is measured by the charge density counter 11. The counted value is a current value flowing through the photo conductor drum, which becomes a value proportional to the surface charge density. On the other hand, the background potential is detected by the potential sensor. From these two values, i.e., the current value flowing through the photo conductor drum and the background potential, the layer thickness of the photo conductor layer is derived.

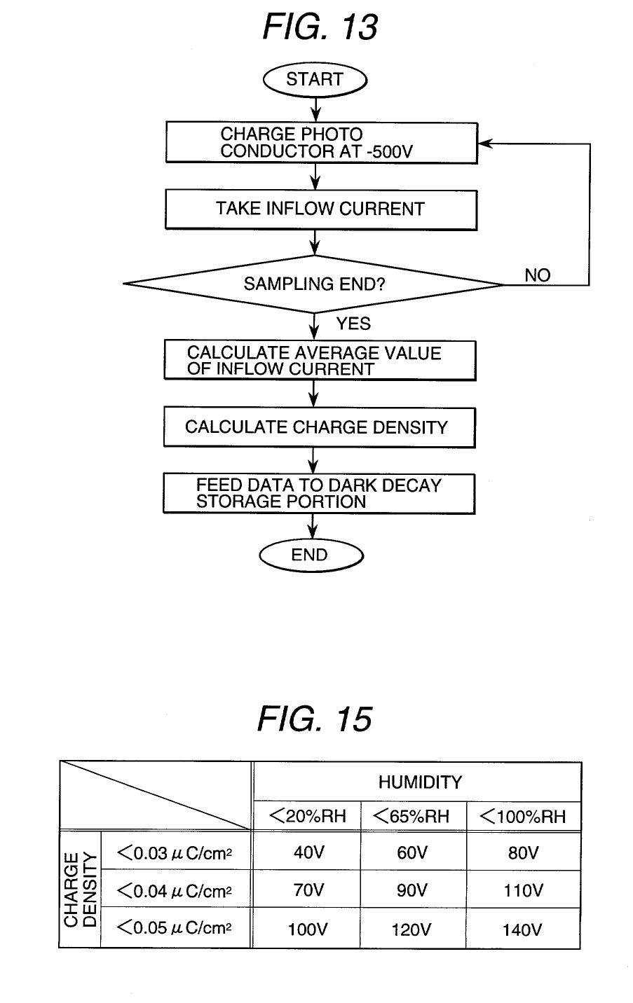

FIG. 13 is a flowchart showing a process for deriving the surface charge density of the photo conductor. It should be noted that determination of the layer thickness of the photo conductor layer in similar manner is possible even when the scorotron charger is employed in the shown embodiment of the image forming apparatus. However,.at this time, since the charge density counter 11 counts the current value flowing through the photo conductor drum 1, counting is performed with subtracting current flowing through the grid and shield from the current applied to the wire.

Next, as another embodiment, an application sequence of the developing bias upon initiation of printing will be discussed with reference to FIGS. 16 to 18. FIG. 16 is a diagrammatic illustration showing a section of the shown embodiment of the image forming apparatus. In FIG. 16, the reference numeral 1 denotes the photo conductor drum, 2 denotes the charger, 3 denotes the developing device, 4 denotes the printing paper, 5 denotes the transfer device, 6 denotes the fixing device, 7 denotes the cleaning device, 8 denotes the exposure device and 16 denotes the developing bias control portion.

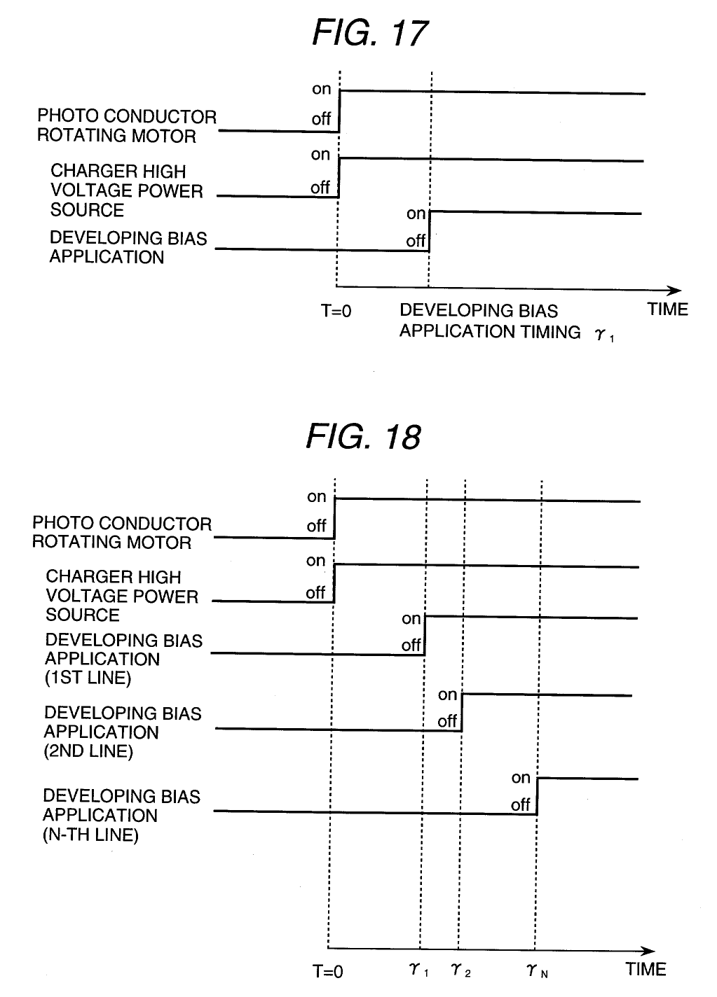

FIG. 17 shows a control sequence of respective portion of the printing and transferring unit upon starting printing. At first, a motor for rotatingly driving the photo conductor and a voltage supply device of the charger for charging the photo conductor are actuated. A period within which the surface potential of the photo conductor reaches the potential equal to the developing bias or higher is preliminarily measured. After the preliminarily measured period, the developing bias is applied. A period for rising the potential of the photo conductor is variable depending upon the photo conductor to be used.

In case of the developing device having a plurality of developing rollers, timing to apply the developing bias is sequentially applied from upstream side in rotating direction of the photo conductor. After exposure, a timing of the developing bias to be applied to the first developing roller is assumed as γ₁. Then, application timings for applying the developing bias for (N)th developing roller is expressed by

γ_{N}=γ_{N-1}+(N−1)×L/v,

wherein L is a distance between developing nips of the (N)th developing roller and (N−1)th developing roller, and v is a process speed.

FIG. 18 is a timing chart of developing bias application of the development device having a plurality of developing rollers. By setting application timing of the developing bias, extra toner will not deposit on the photo conductor. By this, even the image forming apparatus of roller transfer system or belt transfer system, stain of the transfer device by toner is prevented to make exchanging cycle of transfer parts longer. On the other hand, since it can avoid transfer of the extra amount of toner to the cleaning device, it becomes possible to expand exchanging cycle of the cleaning member (blade, brush or the like).

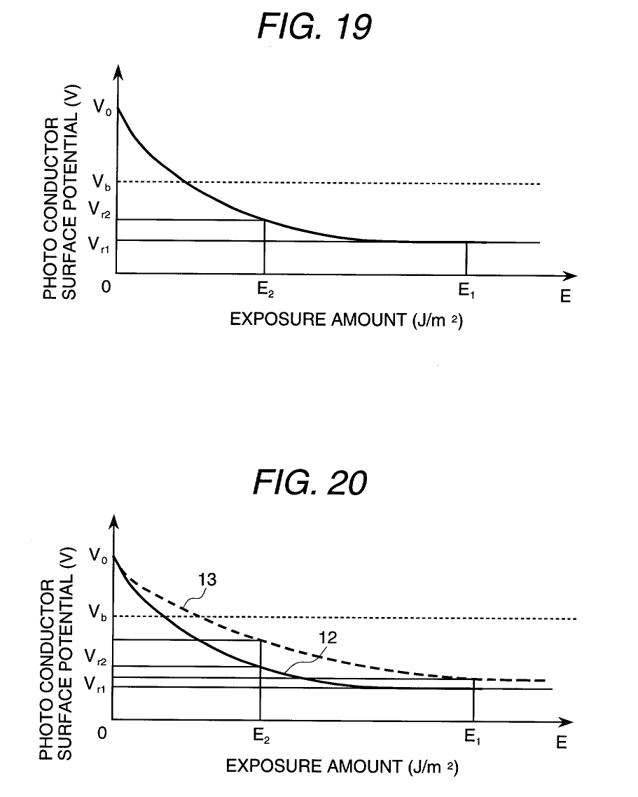

Next, variation of the layer thickness of the photo conductor on the photo conductor drum and control of peripheral electric field will be discussed with reference to FIGS. 19 to 25.

In the shown embodiment, the potential of the surface of the photo conductor drum 1 is detected by the potential sensor 10. On the basis of the detection value, an exposure amount of the exposure device 8 can be adjusted by the exposure control means 9. On the other hand, the charge density on the surface of the photo conductor drum 1 can be counted by the charge density counter 11 to adjust exposure amount of the exposure device 8 on the basis of the counted value by the exposure control means 9.

FIG. 19 is an explanatory illustration showing an optical response characteristics of the photo conductor drum 1. In FIG. 19, the horizontal axis represents an exposure amount and illustrated with an optical energy applied to the photo conductor drum 1. The vertical axis represents a potential of the photo conductor drum 1 within a given period after exposure. A period after exposure is set to be equal to the period required from exposure to the development in the shown embodiment of the image forming apparatus. In the vertical axis, V0 shows the background potential (charge potential) in development. In the shown device, the exposure amount by the exposure control means 9 is variable between two stages respectively represented by E1 and E2. Vr1 in vertical axis represents a potential on the photo conductor 1 corresponding to the exposure amount E1, and Vr2 is a potential on the photo conductor 1 corresponding to the exposure amount E2. Vb represents a bias voltage of the developing device, and Vb−Vr1 and Vb−Vr2 are developing potential difference, respectively. The exposure control means 9 is controlled so that, for a wide solid region (solid image), Vb−Vr1 is used as the developing potential, and on the other hand, for line drawing or halftone dot, to which peripheral effect of the electric field acts strongly, the Vb−Vr2 is used as the developing potential.

Here, discussion will be given for variation in elapsed time of the electrostatic latent image on the photo conductor surface. When degree of fatigue is increased according to increasing printing amount, the potential (charge potential) of the charge region is lowered to charging becomes difficult. Accordingly, lowering of the background potential V0 is caused. However, since the shown embodiment employs scotoron type charger is employed as the charger, only slight lowering of the background potential V0 is caused. On the other hand, the potential (discharge potential of discharge region is elevated to make discharge difficult. Lowering of discharge performance is significant when an intermediate potential region not completely radiated is provided by not providing sufficient exposure amount. In the shown embodiment, the intermediate potential is Vr2.

The foregoing variation of potential makes development potential difference smaller to serve for lowering the developing electric field. On the other hand, in addition to these characteristics, according to increase of the printing amount, thickness of the photo conductor layer of the photo conductor is reduced by wearing. Reduction of the developing electric field due to reduction of the developing potential difference can be said with respect to both of the peripheral electric field and internal parallel electric field portion.

However, increasing of the developing electric field due to reduction of the layer thickness of the photo conductor layer is caused only in the peripheral electric field. An image, for which two opposite tendencies are significant, are line drawings, dots or edge portion of the solid region to be influenced by developing electric field by the peripheral effect. Which of mutually opposite tendency is dominant is variable depending upon the printing apparatus and history of printing and so forth. Namely, variation of developing performance is caused according to elapsed time to cause variation of image quality. This means that mode of variation is variable depending upon the printing apparatus or even in the apparatus of the same construction, depending upon history of printing.

FIG. 20 is an explanatory illustration showing optical response characteristics of the photoconductive drum 1 similar to FIG. 19. In FIG. 20, there are illustrated two conditions, i.e. initial condition and a condition of end of life where fatigue is progressed. In FIG. 20, the solid line (12) shows the initial condition and the broken line (13) shows the fatigued condition. Due to fatigue, V0 is lowered but falls within a range not significantly affecting for the image quality. It should be appreciated that influence of fatigue is greater in case of the potential (Vr2) corresponding to E2 in comparison with the potential (Vr1) corresponding to E1.

Accordingly, in the shown embodiment of the image forming apparatus, the exposure amount E2 is variable to control the exposure amount E2 for maintaining the surface potential Vr2 of the photo conductor drum 1 constant.

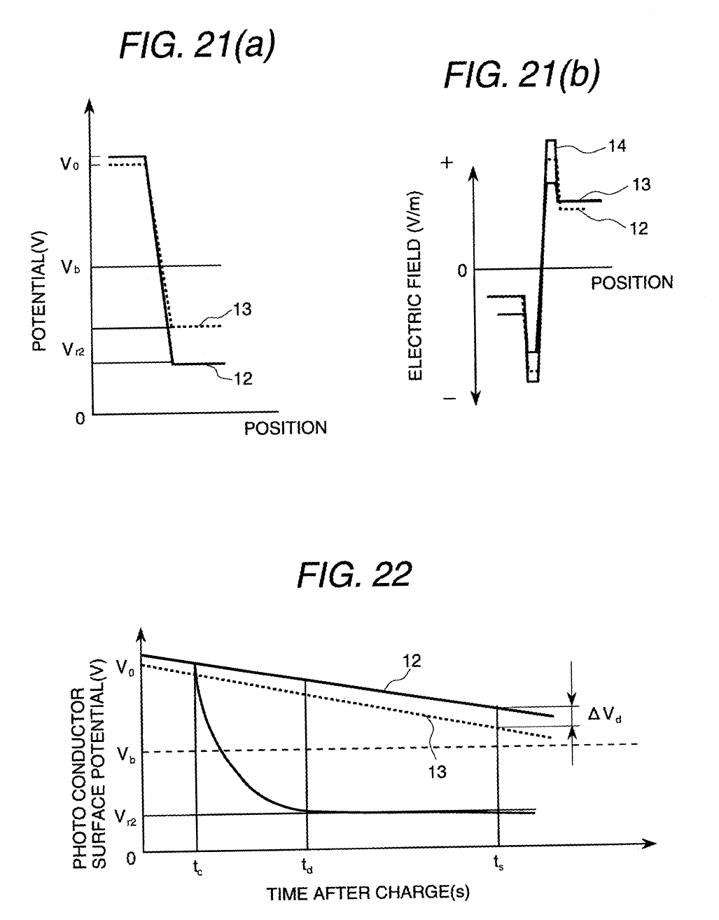

FIGS. 21A and 21B show examples of the potential and electric field distribution of the latent image on the photo conductor drum 1. FIG. 21A shows potential distribution, and FIG. 21B shows electric field distribution. Concerning the condition of the photo conductor drum 1, the solid line (12) shows the case where the photo conductor is in initial condition and thus the control is not applied for the exposure amount E2, and the broken line (13) is the case where the photo conductor is in fatigue condition and thus control is applied for the exposure amount E2. As discussed in connection with FIG. 20, the photo conductor drum 1 cause fatigue to lower V0, Vr2 is risen and the developing potential is lowered. Conversely, due to reduction of the layer thickness of the photo conductor 1 on the photo conductor drum 1, the developing electric field corresponding to the developing potential is increased. FIG. 21B shows the electric field distribution in the case where Vr2 is controlled to be constant. Increasing of the developing electric field becomes significant.

ON the other hand, FIGS. 21A and 21B shows the case where the developing electric field is increased when control for keeping Vr2 constant is not applied. In different fatigue condition of the photo conductor drum 1, it is possible that the developing electric field is lowered. In either case, when control for making Vr2 constant, only influence due to reduction of the layer thickness is caused, the development electric field is increased.

As set forth above, the electric field is increased by two independent factors of the potential difference and the layer thickness. Accordingly, it becomes necessary to control both of the potential and the electric field constant for stably maintaining image quality constant in elapsed time. The potential is controlled to be constant by deriving the potential in the developing device 3 from detection value of the potential sensor 10 and adjusting the exposure amount of the exposure device 8 by the exposure control means 9 on the basis of the derived value. On the other hand, for controlling the electric field, it is, at first, required to know the strength of the electric field. Strength of the of the electric field is determined by the layer thickness of the photo conductor as set forth above.

Accordingly, when the layer thickness of the photo conductor can be detected with high precision, control of the electric field becomes possible.

FIG. 22 shows variation of the surface potential of the photo conductor drum 1 after charging. In FIG. 22, the vertical axis represents the surface potential of the photo conductor and the horizontal axis represents the elapsed period after charging. In FIG. 22, te represents an exposure timing by the exposing device 8, td represents the developing timing by the developing device 3, and ts denotes the potential detection timing by the potential sensor 10. Concerning the photo conductor drum 1, the solid line (12) is the initial condition and the broken line is fatigued condition. Abrupt lowering of the surface potential from the exposure timing te shows variation of potential in a region of thin line or dot image region where the developing potential becomes Vr2 at the developing timing td among light irradiating portion of the surface of the photo conductor.

The surface potential of the photo conductor constantly lowering before and after the exposure timing te represents the potential variation of the background where the light is nor irradiated. Such constant lowering of potential is caused by dark decay. For using scorotron charger 2, the surface potential of the photo conductor upon charging (time 0) becomes slightly higher in case of the initial condition of the photo conductor drum in comparison with that in the fatigued condition. However, difference is quite small and can be ignored.

In the shown embodiment, ignoring such small difference, it is considered that the surface potential of the photoconductor upon charging (time 0) is substantially constant irrespective of the fatigue condition. On the other hand, on the basis of the detection value of the potential sensor 10, the exposure amount is adjusted so that Vr2 is constant. Therefore, variation of the potential in the thin line or dot image region is substantially constant irrespective of the fatigue condition of the photo conductor drum.

On the other hand, the dark decay speed is higher in the fatigued condition in comparison with the initial condition of the photo conductor drum. Attenuation speed difference is caused due to difference of the layer thickness of the photo conductor since the potential at the charging timing is substantially equal. The difference of the charge potential due to difference of the fatigue condition of the photo conductor is shown as the dark decay potential difference ΔVd.

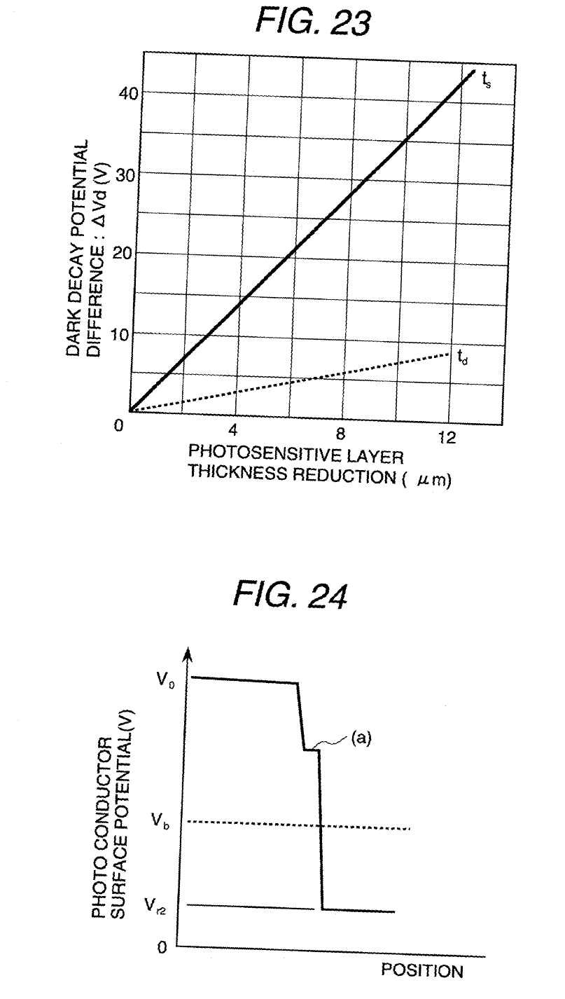

FIG. 23 is an illustration showing variation of the dark decay potential difference ΔVd as measured at the potential detection timing ts by the potential sensor 10 and as measured at the developing timing td by the developing device 3. By detecting the dark decay potential difference ΔVd, reduction of the layer thickness of the photo conductor can be seen. However, at the developing timing td, the dark decay potential difference ΔVd is quite small in the extent that lowering of the background potential does not influence for the image, and the sufficient resolution (precision) of the output of the potential sensor for detecting the difference cannot be obtained. Accordingly, in the shown embodiment where the potential sensor 10 is provided downstream side of the transfer device 5, the large dark decay potential difference ΔVd appears. Therefore, the dark decay potential difference ΔVd can be obtained with sufficiently high precision by measuring the background portion potential to make reduction of the layer thickness of the photo conductor at that timing clear.

With the construction set forth above, by detecting reduction of the layer thickness of the photo conductor by way of the method measuring only charge potential, high precision detection of the layer thickness of the photo conductor becomes possible.

Conversion from the output of the potential sensor 10 to the reduction component of the layer thickness of the photo conductor can be calculated by the exposure control means 9, to which the initial background potential at the position of the potential sensor 10 is input. Also, the reduction amount of the layer thickness and increasing component of the peripheral current are preliminarily known and are stored in the exposure control means I in the from of the table. The value corresponding to expansion of the peripheral electric field is determined on the basis of the internal table. On the basis of this value, the control by exposure for weaken the peripheral electric field depending upon reduction amount of the later thickness is provided from time to time.

FIG. 24 is an illustration showing a potential distribution of the surface of the photo conductor drum 1 upon development upon performing control for weaken the foregoing peripheral electric field (hereinafter referred to as electric field control). In FIG. 24, slight stepwise potential distribution as shown by (a) is caused on the way of variation from the charge potential to the discharge potential. This position corresponds to the position around the image and is formed by lowering the exposure amount. It should be noted that the exposure for forming the stepwise distribution is referred to as auxiliary exposure. While dedicated exposure device may be newly employed for the auxiliary exposure, it is also possible to make the exposure amount of the exposure device 8 into multi-value.

By the auxiliary exposure, abrupt potential variation around the image is prevented. As a result, peripheral electric field can be weaken. On the other hand, a step portion of the stepwise distribution is provided between the bias voltage Vb and the background potential V0. If the step portion is provided between the bias voltage Vb and the discharge potential Vr2, the step portion falls within the image region to cause variation of density at the position corresponding to the step portion to form low density region from the step portion to outside of the image region.

Accordingly, by providing the step portion between the bias voltage Vb and the background potential V0 outside of the image region, the problem that presence of the step portion appears on the image, can be avoided. A dot density of the shown embodiment of the image forming apparatus is 600 dot/inch. The image signal is taken in the memory before exposure and periphery of all images are detected by pattern matching method to apply auxiliary exposure for two dots along the periphery of the image. The foregoing internal table of the exposure control means is prepared in relation to the layer thickness of the photo conductor layer and the auxiliary exposure amount. Thus, intensity of the auxiliary exposure is determined depending upon the layer thickness of the photo conductor.

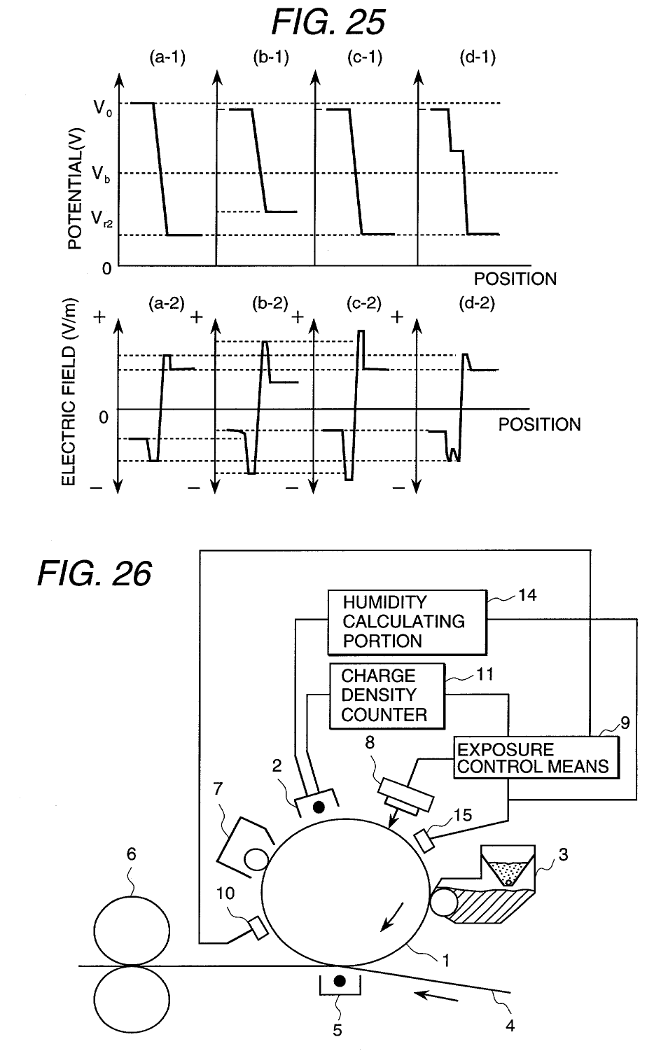

In FIG. 25, (a-1) shows surface potential distribution including the Vr2 image region of the photo conductor in initial condition, in the shown embodiment, and (a-2) shows electric field distribution corresponding to (a-1) of the photo conductor in the initial condition, (b-1) shows surface potential distribution including the Vr2 image region of the photo conductor in fatigued condition, in the shown embodiment, and (a-2) shows electric field distribution corresponding to (a-1) of the photo conductor in the fatigued condition, (c-1) shows surface potential distribution including the Vr2 image region of the photo conductor in fatigued condition when only potential is controlled to be constant in the shown embodiment, and (c-2) shows electric field distribution corresponding to (c-1), (d-1) shows surface potential distribution including the Vr2 image region of the photo conductor in fatigued condition when the potential and electric field are controlled according to the method of the shown embodiment, and (d-2) shows electric field distribution corresponding to (d-1).

Comparing (a-1) and (a-2) of FIG. 25 and (d-1) and (d-2) of FIG. 25, by controlling the potential in the image portion constant and controlling the electric field by forming stepwise distribution by the auxiliary exposure on the way from the charge potential to discharge potential (potential of exposure portion), the potential and the electric field of the image portion can be maintained in the same condition as the initial condition even in the photo conductor in fatigued condition.

In the shown embodiment, in the wide solid region (solid image) where parallel electric field and peripheral electric field are present in admixing manner, the discharge potential of Vr1 is used. Since Vr1 is relatively stable potential, control for maintaining the potential constant is not applied. However, even in this region, increase of the electric field due to reduction of the layer thickness of the photo conductor to apply electric field control by the auxiliary exposure similarly to the discharge potential region of Vr2. By this, even in the wide solid region (solid image) where the parallel electric field and peripheral electric field are present admixing manner, image quality can be maintained stably even upon occurrence of fatigue of the photo conductor.

In the embodiment set forth above, since the reduction of the layer thickness of the photo conductor is detected by measuring only charge potential at the position downstream of the developing position, it may not be influenced by exposure to permits detection of the photo conductor with high precision. On the other hand, by forming the stepwise distribution by auxiliary exposure, the electric field can be controlled to maintain the potential and electric field in the image portion even in the photo conductor in fatigued condition comparable with those in the photo conductor in initial condition. On the other hand, even for the wide solid region (solid image) where the parallel electric field and peripheral electric field are present in admixing manner by applying the auxiliary exposure for the peripheral portion of the image, image quality can be maintained stably even upon fatigue condition of the photo conductor.

Furthermore, by providing the step portion formed by the auxiliary exposure between the bias voltage Vb and the background potential V0 outside of the image region, presence of the step portion will not be perceptible on the image.

Next, another embodiment of the present invention will be discussed.

FIG. 26 is a diagrammatic illustration of the section of another embodiment of the image forming apparatus according to the present invention. In FIG. 26, the reference numeral 14 denotes a charge control device, 15 denotes a second potential sensor. The shown embodiment of the image forming apparatus has the same construction and operation as the embodiment shown in FIG. 1 except that the charge control device 14 and the second potential sensor 15 are added and operation and effect associated with these additional components are added.

As set forth above, in the shown embodiment, associating with the fatigue of the photo conductor, the charge potential (V0) at the charge timing is lowered even slightly. A cause of lowering of potential is not purity by reduction of the layer thickness of the photo conductor but also by influence of fatigue of other characteristics. The potential measurement value after dark decay by the potential sensor 10 becomes a value slightly including measurement error as a potential lowering component. Therefore, a problem is encountered in increasing of blooming in the background portion as time elapsed. In the shown embodiment, the background potential (V0) is detected by the second potential sensor 15 to measure lowering of the background-potential (V0) in the charge control device 14. A grid voltage of the charger 2 is controlled depending the measured value so that the background potential (V0) becomes strictly constant. By this, since the potential drop after dark decay can be measured accurately, reduction amount of the layer thickness of the photo conductor can be detected accurately.

Furthermore, in the shown embodiment, the discharge potential Vr2 is detected even by the second potential sensor 15 to derive the potential in the developing device 3 on the basis of the detection value from the potential sensor 10. Since the developing device 3 is located at the position between two potential sensors 10 and 15, the discharge potential Vr2 at the position of the developing device 3 can be calculated accurately.

As set forth above, with the shown embodiment, since the second potential sensor 15 is located between the charger 2 and the developing device 3 to control the charge potential (background potential V0) constant, reduction of the layer thickness of the photo conductor can be detected more accurately. On the other hand, since the discharge potential Vr2 at the position of the developing device 3 is calculated on the basis of the two detection values from the potential sensors 10 and 15 located at both sides of the developing device 3, the discharge potential Vr2 is accurately controlled.

Subsequently, a further embodiment of the image forming apparatus according to the present invention will be discussed.

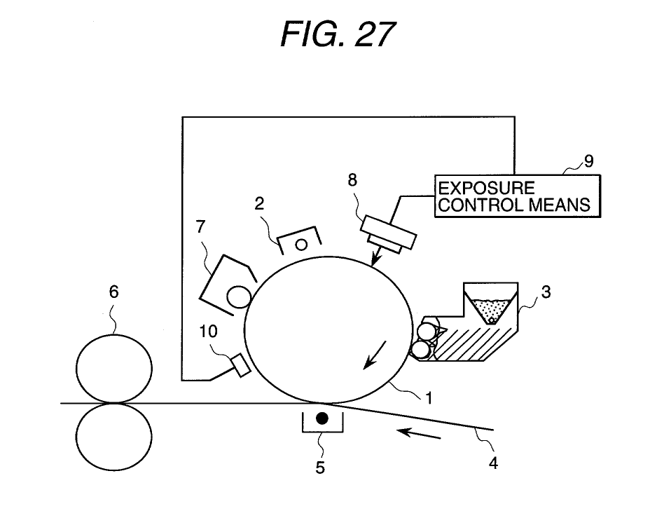

FIG. 27 is a diagrammatic illustration of the section of the further embodiment of the image forming apparatus according to the invention. In the device shown in FIG. 1, the developing roller of the developing device 3 is single and rotating direction the developing roller is the same as the rotating direction of the photo conductor drum 1 at the position mating with the photo conductor drum 1.

In the shown embodiment of the developing device, the rotating directions of adjacent developing rollers are differentiated so that respective developing rollers are rotated toward the photo conductor from the position where two developing rollers are opposed with each other. From the position where the developing rollers are opposed with each other, the developer is separately carried toward the photo conductor. It should be noted that, in the shown embodiment, two-component developer consisted of toner and carrier is used in the developing device 3.

As can be appreciated from (d-2) of FIG. 25, in the shown embodiment of the image forming apparatus, a magnitude of the peripheral electric field developed in the background portion is suppressed to be equivalent to the photo conductor in initial condition. However, since the auxiliary exposure is added, the peripheral electric field has two small valleys and the width is slightly increase in the width of the auxiliary exposure. In this case, a problem of terminal deletion, in which the rear end of the image relative to the rotating direction of the developing roller on the surface of the photo conductor drum 1 is difficult to be developed. The terminal deletion is caused by mechanical factor that the magnetic brush frictionally contacts with the surface of the photo conductor, abrupt variation of the potential of the photo conductor from the background potential (V0) to the potentials (Vr1 and Vr2) of the image portion in the extent that the electric characteristics of the developer as a mixture of the carrier bead and toner cannot follow such abrupt variation.

By employing two developing roller type developing device as in the shown embodiment, since rotating directions of two developing rollers are different, rear end sides relative to the rotating direction of the developing roller are different in respective developing rollers. By this, the developing rollers compensate with each other to eliminate the problem of terminal deletion that end portion of the image is difficult to be developed.

As set forth above, by the embodiment, the problem of the terminal deletion can be eliminated to stably object high image quality as time elapsed. It should be noted that detection of the layer thickness of the photo conductor can be performed simultaneously with printing. However, in order to further enhance precision in detection, it is preferred to perform detection of the layer thickness of the photo conductor separately from printing. Particularly, by performing detection of the layer thickness of the photo conductor before initiation of printing, the potentials in the image region and the background region can be detected more accurately.

As set forth above, with the present invention, when the potential sensor for detecting the potential patch is provided downstream side of the developing device of multiple stage developing rollers, disturbance of the potential patch can be restricted to stably reproduce high quality of image over a long period.

Also, even when the transfer roller or transfer belt is used in the transfer device, contamination of the transfer roller or transfer belt by toner can be successfully prevented.

Furthermore, since extra toner is not deposited on the photo conductor, life of the cleaning device can be expanded.

Although the present invention has been illustrated and described with respect to exemplary embodiment thereof, it should be understood by those skilled in the art that the foregoing and various other changes, omission and additions may be made therein and thereto, without departing from the spirit and scope of the present invention. Therefore, the present invention should not be understood as limited to the specific embodiment set out above but to include all possible embodiments which can be embodied within a scope encompassed and equivalent thereof with respect to the feature set out in the appended claims.

What is claimed is:

1. An image forming apparatus comprising:
charging means for charging an image carrier;
exposure means for exposing image on the charged image carrier for forming a latent image;
developing means including a plurality of developing rollers arranged in opposition with a surface of said image carrier and biasing applying means for applying a developing bias to said plurality of developing roller, for supplying a developer on said image carrier and forming a developed image on said image carrier;
transfer means for transferring the developed image formed on said image carrier onto a printing medium;
a potential sensor provided downstream side of moving direction of said image carrier relative to said developing means for detecting a potential on said image carrier; and
control means for setting said developing bias to a value restricting disturbance of a potential portion as an object for potential detection by said potential sensor by the developer when said potential portion passes across said developing means.

2. An image forming apparatus as set forth in claim 1, wherein setting of the developing bias for said plurality of developing rollers is performed in sequential order from the developing roller arranged on upstream side in the moving direction of the image carrier.

3. An image forming apparatus as set forth in claim 1, which further comprises:
layer thickness detecting means for detecting a layer thickness of said image carrier;
a humidity sensor for detecting humidity around said image carrier; and.
dark decay storage means for storing a potential drop amount due to dark decay of said image carrier corresponding to detection values of said layer thickness detecting means and said humidity sensor, and
at least one of a charge voltage of said charging means and a light amount of said exposure means is corrected on the basis of the potential drop derived from the detection values of said layer thickness detecting means and said humidity sensor.

4. An image forming apparatus comprising:
an image carrier;
charging means for charging an image carrier;
exposure means for exposing image on the charged image carrier for forming a exposure portion potential;
developing means including a plurality of developing rollers arranged in opposition with a surface of said image carrier, biasing applying means for applying a developing bias to said plurality of developing roller and a two component developer, for supplying a developer on said image carrier and forming a developed image on said image carrier;
transfer means for transferring the developed image formed on said image carrier onto a printing medium;
a potential sensor provided downstream side of moving direction of said image carrier relative to said developing means for detecting a potential on said image carrier; and
control means for avoiding said developing bias to a value for restricting deposition of toner to said exposure portion potential when said exposure portion potential region passes across said developing means.

5. An image forming apparatus as set forth in claim 4, wherein the developing bias is avoided in sequential order from the developing roller arranged upstream side in moving direction of said image carrier upon avoiding developing bias of a plurality of developing rollers.

6. An image forming apparatus as set forth in claim 4, wherein the developing bias is applied in sequential order from the developing roller arranged upstream side in moving direction of said image carrier upon applying developing bias of a plurality of developing rollers.

7. An image forming apparatus as set forth in claim 4, which further comprises:
layer thickness detecting means for detecting a layer thickness of said image carrier;
a humidity sensor for detecting humidity around said image carrier; and
dark decay storage means for storing a potential drop amount due to dark decay of said image carrier corresponding to detection values of said layer thickness detecting means and said humidity sensor, and
at least one of a charge voltage of said charging means and a light amount of said exposure means is corrected on the basis of the potential drop derived from the detection values of said layer thickness detecting means and said humidity sensor.

8. An image forming apparatus comprising:
an image carrier;
charging means for charging an image carrier;
exposure means for exposing image on the charged image carrier for forming a exposure portion potential;
developing means including a plurality of developing rollers arranged in opposition with a surface of said image carrier, biasing applying means for applying a developing bias to said plurality of developing roller and a two component developer, for supplying a developer on said image carrier and forming a developed image on said image carrier;
transfer means for transferring the developed image formed on said image carrier onto a printing medium;
a potential sensor provided downstream side of moving direction of said image carrier relative to said developing means for detecting a charge potential and an exposure potential on said image carrier; and
control means for applying said developing bias at a value restricting splashing of carrier to the surface of said image carrier when said charge potential region passes through said developing means, and avoiding said developing bias to a value for restricting deposition of toner to said exposure portion potential when said exposure portion potential region passes across said developing means.

9. An image forming apparatus as set forth in claim 8, wherein the developing bias is avoided in sequential order from the developing roller arranged upstream side in moving direction of said image carrier upon avoiding developing bias of a plurality of developing rollers.

10. An image forming apparatus asset forth in claim 8, wherein the developing bias is applied in sequential order from the developing roller arranged upstream side in moving direction of said image carrier upon applying developing bias of a plurality of developing rollers.

11. An image forming apparatus as set forth in claim 8, which further comprises:
layer thickness detecting means for detecting a layer thickness of said image carrier;
a humidity sensor for detecting humidity around said image carrier; and
dark decay storage means for storing a potential drop amount due to dark decay of said image carrier corresponding to detection values of said layer thickness detecting means and said humidity sensor, and
at least one of a charge voltage of said charging means and a light amount of said exposure means is corrected on the basis of the potential drop derived from the detection values of said layer thickness detecting means and said humidity sensor.

12. An image forming apparatus comprising:
an image carrier;
charging means for charging an image carrier;
exposure means for exposing image on the charged image carrier for forming a exposure portion potential;
developing means including a plurality of developing rollers arranged in opposition with a surface of said image carrier, biasing applying means for applying a developing bias to said plurality of developing roller and a two component developer, for supplying a developer on said image carrier and forming a developed image on said image carrier;
transfer means for forming a transfer nip portion by contacting with the surface of said image carrier and transferring the developed image formed on said image carrier onto a printing medium in said transfer nip;
a potential sensor provided downstream side of moving direction of said image carrier relative to said developing means for detecting a charge potential and an exposure potential on said image carrier; and
control means for applying said developing bias at a value restricting splashing of carrier to the surface of said image carrier when said charge potential region passes through said developing means, and avoiding said developing bias to a value for restricting deposition of toner to said exposure portion potential when said exposure portion potential region passes across said developing means.

13. An image forming apparatus as set forth in claim 12, wherein the developing bias is avoided in sequential order from the developing roller arranged upstream side in moving direction of said image carrier upon avoiding developing bias of a plurality of developing rollers.

14. An image forming apparatus as set forth in claim 12, wherein the developing bias is applied in sequential order from the developing roller arranged upstream side in moving direction of said image carrier upon applying developing bias of a plurality of developing rollers.

15. An image forming apparatus as set forth in claim 12, which further comprises:
layer thickness detecting means for detecting a layer thickness of said image carrier;
a humidity sensor for detecting humidity around said image carrier; and
dark decay storage means for storing a potential drop amount due to dark decay of said image carrier corresponding to detection values of said layer thickness detecting means and said humidity sensor, and
at least one of a charge voltage of said charging means and a light amount of said exposure means is corrected on the basis of the potential drop derived from the detection values of said layer thickness detecting means and said humidity sensor.

16. An image forming apparatus comprising:
an image carrier;
charging means for charging an image carrier;
exposure means for exposing image on the charged image carrier for forming a exposure portion potential;
developing means including a developing roller arranged in opposition with a surface of said image carrier, biasing applying means for applying a developing bias to said developing roller and a two component developer, for contacting the developer held on said developing roller to the surface of said image carrier to form a developing nip and supplying a developer on said image carrier and forming a toner image on said image carrier in said developer nip;
transfer means for transferring the toner image formed on said image carrier onto a printing medium in said transfer nip;
a potential sensor provided downstream side of moving direction of said image carrier relative to said developing means for detecting a charge potential and an exposure potential on said image carrier; and
control means for avoiding said developing bias to a value for restricting deposition of toner to said exposure portion potential when a tip end of said exposure portion potential region reaches a rear end of said developing nip in moving direction of said image carrier.

17. An image forming apparatus as set forth in claim 17,which comprises means for controlling a potential of an image region on the basis of a detection value of said potential sensor constant, detecting a layer thickness of a photo conductor layer forming said image carrier, and controlling peripheral electric field of said image region.

18. An image forming apparatus as set forth in claim 17, which includes:
a first potential sensor arranged within a range from said developing means toward said charging means in said moving direction of said image carrier, and
a second potential sensor arranged within a range from said charging means toward said developing means in said moving direction of said image carrier,
a potential of said charge potential region is controlled to be constant on the basis of a detection value of said second potential sensor, and the layer thickness of said photo conductor is detected on the basis of a detection value of said first potential sensor.

19. An image forming apparatus as set forth in claim 17, which employs an auxiliary exposure for controlling said peripheral electric field, an auxiliary exposure light is irradiated at a position of transition from a potential of said charge potential region to the exposure potential region for forming stepwise potential distribution.

20. An image forming apparatus as set forth in claim 18, wherein at least one stepwise potential distribution is formed between said developing bias voltage and a potential of said charge potential region.

21. An image forming apparatus as set forth in claim 1, which further comprises means for detecting a potential of an image region where is a region of said latent image, by said potential sensor, controlling the potential of the image region other than solid image region among said image region on the basis of detection values thereof, detecting a later thickness of said photo conductor and controlling a peripheral electric field of said image region including the solid image.
